(19) United States
(12) Patent Application Publication
(10) Pub. No.: US 2026/0253918 A1
(43) Pub. Date: Aug. 27, 2026

(54) FUEL CELL STACK

(71) Applicant: TOYOTA BOSHOKU KABUSHIKI KAISHA, Aichi-ken (JP)

(72) Inventors: Haruyuki AONO, Aichi-ken (JP); Satoshi KAWABE, Ichinomiya-shi (JP); Akihiro INUKAI, Okazaki-shi (JP)

(73) Assignee: TOYOTA BOSHOKU KABUSHIKI KAISHA, Aichi-ken (JP)

(21) Appl. No.: 19/541,852

(22) Filed: Feb. 17, 2026

(30) Foreign Application Priority Data
Feb. 26, 2025 (JP) 2025-028672

(51) Int. Cl. H01M 8/0267; H01M 8/026; H01M 8/0263; H01M 8/0265; H01M 8/2483

(52) U.S. Cl. CPC H01M 8/0267; H01M 8/026; H01M 8/0263; H01M 8/0265; H01M 8/2483

(57) ABSTRACT

A cooling passage of a second surface of each of two separators includes undulating portions extending in an undulating manner in a first direction and arranged in a second direction, and a connecting portion that connects a first end of one of the undulating portions to a second end of an adjacent one of the undulating portions in the second direction. A cooling medium supply manifold and a cooling medium discharge manifold are located at opposite sides of the cooling passage in the first direction. The undulating portions include at least a first undulating portion and a second undulating portion located upstream of the first undulating portion with respect to a flow direction of reactant gas. A fuel cell stack is formed so that cooling medium flowing through the first undulating portion has a greater pressure loss than cooling medium flowing through the second undulating portion.

### CROSS-REFERENCE TO RELATED APPLICATIONS

This application is based upon and claims the benefit of priority from Japanese Patent Application No. 2025-28672, filed on Feb. 26, 2025, the entire contents of which are incorporated herein by reference.

### BACKGROUND

### 1. Field

The present disclosure relates to a fuel cell stack.

### 2. Description of Related Art

JP2009-170286A discloses a fuel cell including stacked unit cells. Each unit cell includes a membrane electrode assembly (MEA), which includes a polymer electrolyte membrane, and two separators, which hold the MEA in between. The unit cell is rectangular and has long sides and short sides.

One longitudinal end of the unit cell includes three manifolds for supplying fuel gas, coolant, and oxidant gas into the fuel cell. The other longitudinal end of the unit cell includes three manifolds for discharging the oxidant gas, the coolant, and the fuel gas out of the fuel cell.

The surface of each separator facing the MEA forms gas passages through which reactant gas, which is the fuel gas or the oxidant gas, flows. Each gas passage includes three linear portions and two connecting portions. The three linear portions are arranged in the direction in which the short sides of the unit cell extend. Each connecting portion connects the downstream end of a linear portion to an upstream end of the adjacent linear portion. The gas passage meanders back and forth. In other words, the gas passage has a serpentine configuration.

The surface of each separator opposite the side facing the MEA forms a cooling passage through which coolant flows. The cooling passage has a serpentine shape in the same manner as the gas passage.

The cooling passage, through which the coolant flows, is formed between the separators of two adjacent unit cells that are stacked one above the other in the stacking direction. The separators are in contact with each other and shaped in a manner inverted with respect to each other to form the cooling passage. The coolant flowing through the cooling passage cools the unit cells that are heated when generating electric power.

JP2009-170286A discloses a separator in which the reactant gas flows in a meandering manner from the upstream side to the downstream side of the gas passage. The reactant gas is consumed when the MEA generates electric power. Therefore, the unit cell generates more heat at the upstream side of the gas passage. In contrast, the coolant that flows from the manifold into the space between the two separators does not flow in a meandering manner from the upstream side to the downstream side of the cooling passage, and flows to the downstream side of the cooling passage without passing through the upstream side of the cooling passage. This may result in insufficient cooling of the upstream side of the gas passage in the unit cell, which is where a relatively large amount of heat is generated.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a fuel cell stack includes unit cells stacked one above another. Each of the unit cells includes an electric power generator including a membrane electrode assembly, and two separators sandwiching the electric power generator. Each of the two separators includes a first surface facing the electric power generator, and a second surface opposite the first surface. One of the two separators of one of the unit cells is in contact with one of the two separators of an adjacent one of the unit cells in a stacking direction of the unit cells to allow cooling medium to flow therebetween. A direction orthogonal to the stacking direction is referred to as a first direction, and a direction orthogonal to both the stacking direction and the first direction is referred to as a second direction. The first surface of each of the two separators includes a gas passage meandering back and forth in the first direction while extending in the second direction, in which reactant gas flows through the gas passage. The gas passage of each of the two separators in each of the unit cells is formed so that the reactant gas in the gas passage of one of the two separators flows in a direction opposite to a direction in which the reactant gas in the gas passage of the other one of the two separators flows. The second surface of each of the two separators includes a cooling passage meandering back and forth in the first direction while extending in the second direction, in which the cooling medium flows through the cooling passage. The cooling passage includes undulating portions extending in an undulating manner in the first direction and arranged in the second direction, in which each of the undulating portions includes a first end and a second end in the first direction, and a connecting portion that connects the first end of one of the undulating portions to the second end of an adjacent one of the undulating portions in the second direction. Each of the unit cells includes a cooling medium supply manifold configured to supply the cooling medium to the cooling passage, and a cooling medium discharge manifold configured to discharge the cooling medium from the cooling passage. The cooling medium supply manifold and the cooling medium discharge manifold are located at opposite sides of the cooling passage in the first direction. The undulating portions include at least a first undulating portion and a second undulating portion located upstream of the first undulating portion with respect to a flow direction of the reactant gas. The cooling medium flowing through the first undulating portion has a greater pressure loss than the cooling medium flowing through the second undulating portion.

Other features and aspects will be apparent from the following detailed description, the drawings, and the claims.

### BRIEF DESCRIPTION OF THE DRAWINGS

FIG. 1 is an exploded perspective view showing a unit cell of a fuel cell stack in accordance with an embodiment.

FIG. 2 is a cross-sectional view showing the unit cell of FIG. 1.

FIG. 3 is a plan view showing gas passages in a separator shown in FIG. 1.

FIG. 4 is a plan view showing cooling passages in the separator shown in FIG. 1.

FIG. 5 is a plan view showing the fuel cell stack in a state in which the cooling passages of an anode separator and the cooling passages of a cathode separator overlap each other.

FIG. 6 is a cross-sectional perspective view showing a portion of the fuel cell stack where ribs of the anode separator are in contact with ribs of the cathode separator.

FIG. 7 is a cross-sectional perspective view showing a portion of the fuel cell stack where the ribs of the anode separator are separated from the ribs of the cathode separator.

FIG. 8 is a plan view showing a fuel cell stack of a first modification.

FIG. 9 is a plan view showing a fuel cell stack of a second modification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

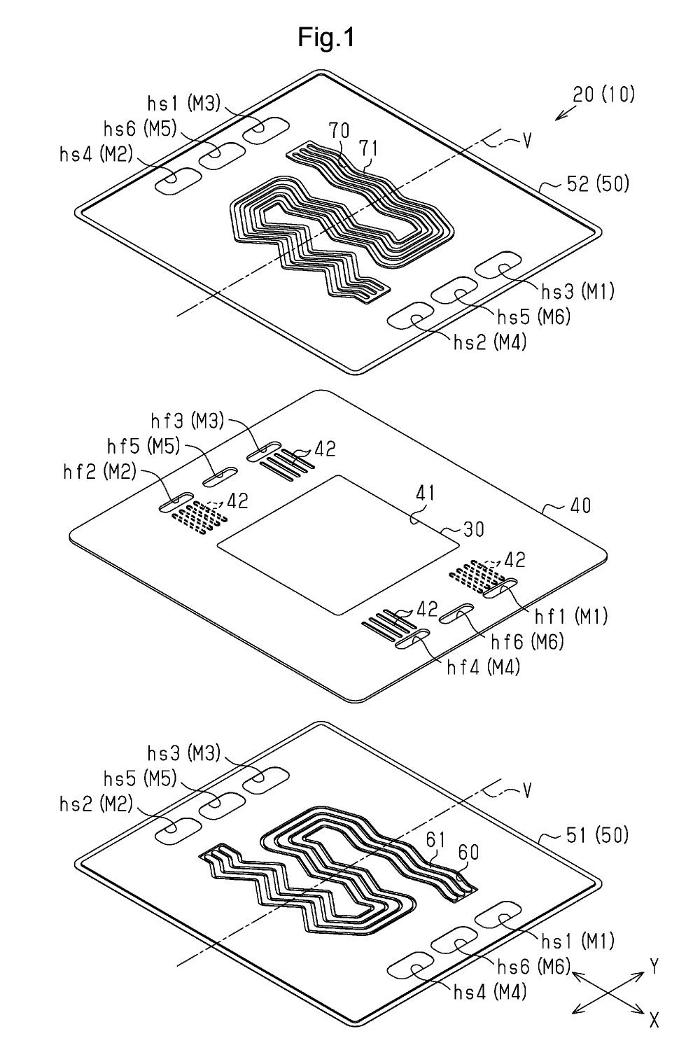

An embodiment of a fuel cell stack will now be described with reference to FIGS. 1 to 7.

### Fuel Cell Stack 10

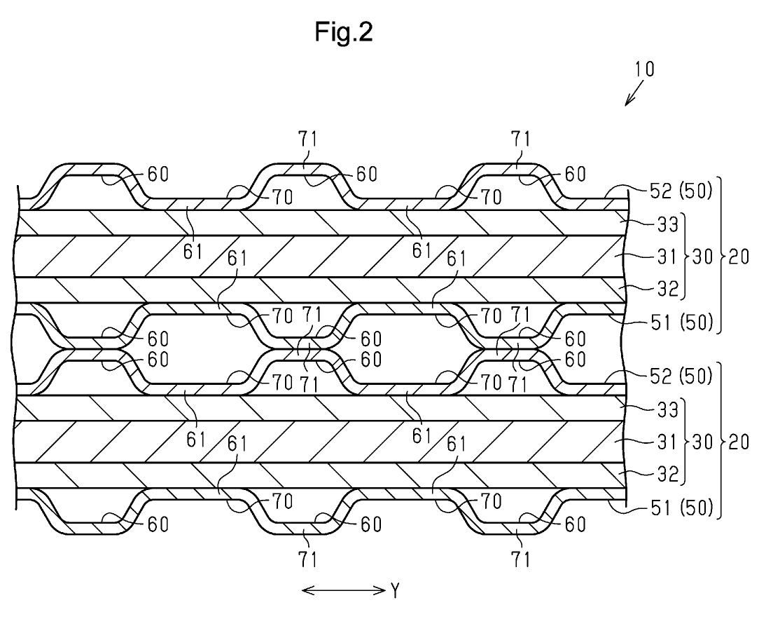

As shown in FIGS. 1 and 2, a fuel cell stack 10 is formed by stacking unit cells 20. The fuel cell stack 10 is, for example, a polymer electrolyte membrane fuel cell.

### Unit Cell 20

As shown in FIG. 1, each unit cell 20 has the shape of, for example, a square plate. That is, the unit cell 20 includes two first sides, which extend parallel to each other, and two second sides, which are orthogonal to the first sides and extend parallel to each other.

In the following description, the direction in which the unit cells 20 are stacked will simply be referred to as the stacking direction. Further, the direction orthogonal to the stacking direction and the direction in which the first sides of the unit cell 20 extend is referred to as an X-axis direction. The direction orthogonal to both the stacking direction and the X-axis direction, that is, the direction in which the second sides of the unit cell 20 extend, is referred to as a Y-axis direction. The X-axis direction is an example of a “first direction”. The Y-axis direction is an example of a “second direction”.

Each unit cell 20 includes a fuel gas supply manifold M1, which supplies fuel gas to the unit cell 20, and a fuel gas discharge manifold M2, which discharges fuel gas out of the unit cell 20. The unit cell 20 includes an oxidant gas supply manifold M3, which supplies oxidant gas to the unit cell 20, and an oxidant gas discharge manifold M4, which discharges oxidant gas out of the unit cell 20. The unit cell 20 includes a cooling medium supply manifold M5, which supplies cooling medium to the fuel cell stack 10, and a cooling medium discharge manifold M6, which discharges cooling medium out of the fuel cell stack 10. The fuel gas is, for example, hydrogen gas. The oxidant gas is, for example, air. The cooling medium is, for example, water.

The fuel gas supply manifold M1, the cooling medium discharge manifold M6, and the oxidant gas discharge manifold M4 are located in one end of the unit cell 20 in the X-axis direction and arranged in this order from one side to the other side in the Y-axis direction. The oxidant gas supply manifold M3, the cooling medium supply manifold M5, and the fuel gas discharge manifold M2 are located in the other end of the unit cell 20 in the X-axis direction and arranged in this order from one side to the other side in the Y-axis direction.

The unit cell 20 includes an electric power generator 30, a frame 40, and two separators 50. The electric power generator 30 has the form of a sheet. The frame 40 surrounds the outer edges of the electric power generator 30. The electric power generator 30 and the frame 40 are held between the two separators 50 from opposite sides in the stacking direction. The electric power generator 30 and the separators 50 are, for example, square in a plan view. The frame 40 is, for example, square in a plan view.

### Electric Power Generator 30

As shown in FIG. 2, the electric power generator 30 includes a membrane electrode assembly 31, an anode-side gas diffusion layer 32, and a cathode-side gas diffusion layer 33. The membrane electrode assembly 31 is held between the anode-side gas diffusion layer 32 and the cathode-side gas diffusion layer 33. The anode-side gas diffusion layer 32 has pores through which fuel gas passes. The cathode-side gas diffusion layer 33 has pores through which oxidant gas passes.

The membrane electrode assembly 31 includes an electrolyte membrane, an anode electrode catalyst layer, and a cathode electrode catalyst layer, which are not shown in the drawings. The electrolyte membrane is held between the anode electrode catalyst layer and the cathode electrode catalyst layer. The anode electrode catalyst layer is formed on the anode-side gas diffusion layer 32. The cathode-side gas diffusion layer 33 is formed on the cathode electrode catalyst layer.

### Frame 40

As shown in FIG. 1, the central part of the frame 40 includes an accommodating hole 41 for accommodating the electric power generator 30. The frame 40 supports the periphery of the electric power generator 30 accommodated in the accommodating hole 41.

The frame 40 is formed by an insulating resin material.

The frame 40, at outer side of the accommodating hole 41, includes through holes hf1, hf2, hf3, hf4, hf5, and hf6 that respectively form parts of

the manifolds M1 to M6.

The frame 40 includes sets of grooves 42 between the accommodating hole 41 and the through holes hf1 to hf4. Each groove 42 is oval and elongated in the X-axis direction. Each set of grooves 42 connects one of the manifolds M1 to M4 to a gas passage 60, which will be described below. The set of grooves 42 located between the accommodating hole 41 and the through hole hf1 , and the set of grooves 42 located between the accommodating hole 41 and the through hole hf2, are open toward an anode separator 51, which will be described below. The set of grooves 42 located between the accommodating hole 41 and the through hole hf3, and the set of grooves 42 located between the accommodating hole 41 and the through hole hf4, are open toward a cathode separator 52, which will be described below.

### Separator 50

Each separator 50 is formed by pressing a metal plate of stainless steel, titanium alloy, pure titanium, or other metals.

One of the two separators 50 is located on the anode-side surface of the electric power generator 30. The other separator 50 is located on the cathode-side surface of the electric power generator 30.

Hereinafter, the separator 50 located on the anode-side surface of the electric power generator 30 may be referred to as the anode separator 51, and the separator 50 located on the cathode-side surface of the electric power generator 30 may be referred to as the cathode separator 52. The anode separator 51 may also be referred to as a first separator, and the cathode separator 52 may also be referred to as a second separator.

The anode separator 51 and the cathode separator 52 are shaped identically. The anode separator 51 and the cathode separator 52 are arranged in a manner inverted relative to each other about the electric power generator 30, or a virtual axis V. The virtual axis V lies along the middle of the separator 50 in the X-axis direction and extends in the Y-axis direction.

Each separator 50 includes through holes hs1 to hs6, which respectively define the manifolds M1 to M6. As described above, the anode separator 51 and the cathode separator 52 are arranged in a manner inverted relative to each other about the electric power generator 30. Thus, the through holes hs1, hs2, hs3, hs4, hs5, and hs6 of the anode separator 51 are connected to the through holes hs3, hs4, hs1, hs2, hs6, and hs5 of the cathode separator 52, respectively.

As shown in FIG. 3, the separator 50 includes a first surface that faces the electric power generator 30. The first surface includes the gas passages 60 and ribs 61 extending along the gas passages 60. Reactant gas flows through the gas passages 60. The gas passages 60 and the ribs 61 are arranged in an alternating manner on the first surface. The separator 50, for example, includes four gas passages 60 extending side by side. Each gas passage 60 has a serpentine shape that meanders back and forth. The gas passages 60 extend in the Y-axis direction while meandering in the X-axis direction.

Fuel gas flows through the gas passages 60 of the anode separator 51 as the reactant gas. Oxidant gas flows through the gas passages 60 of the cathode separator 52 as the reactant gas. The reactant gases flowing through the gas passages 60 are supplied to the electric power generator 30.

The reactant gases in the fuel cell stack 10 are supplied using a counter-flow method in which fuel gas and oxidant gas flow in opposite directions. In other words, the reactant gas in the gas passages 60 of the anode separator 51 flows in a direction opposite to the reactant gas in the gas passages 60 of the cathode separator 52.

Hereinafter, a direction in which the reactant gases flow in the gas passages 60 is simply referred to as a flow direction, an upstream side in the flow direction is simply referred to as the upstream side, and a downstream side in the flow direction is simply referred to as the downstream side.

Each gas passage 60 includes three first extensions Lg and two second extensions Tg. The three first extensions Lg are arranged side by side in the Y-axis direction. Each first extension Lg includes a first end and a second end. Each second extension Tg connects the first end of a first extension Lg to the second end of a first extension Lg adjacent in the Y-axis direction. Each gas passage 60 is substantially S-shaped. The first extensions Lg undulate and extend in a meandering manner in the X-axis direction. Each second extension Tg extends linearly in the Y-axis direction.

In the following description, the three first extensions Lg are referred to as a first extension Lg1, a first extension Lg2, and a first extension Lg3, in order from the upstream side. Further, the two second extensions Tg are referred to as a second extension Tg1 and a second extension Tg2, in order from the upstream side.

The upstream end of the first extension Lg1 is aligned with the through hole hs1 in the X-axis direction and is connected to the through hole hs1 through the grooves 42 (refer to FIG. 1). The second extension Tg1 connects the downstream end of the first extension Lg1 and the upstream end of the first extension Lg2. The second extension Tg2 connects the downstream end of the first extension Lg2 and the upstream end of the first extension Lg3. The downstream end of the first extension Lg3 is aligned with the through hole hs2 in the X-axis direction and is connected to the through hole hs2 through the grooves 42 (refer to FIG. 1). The gas passages 60 face the electric power generator 30 except at the upstream end of the first extension Lg1 and the downstream end of the first extension Lg3.

The three first extensions Lg, which undulate and extend in a meandering manner, have different amplitudes. More specifically, the amplitude of the first extension Lg that is located at the downstream side in the flow direction of the three first extensions Lg has the greatest amplitude. In other words, the amplitude of the first extension Lg2 is greater than the amplitude of the first extension Lg1. The amplitude of the first extension Lg3 is greater than the amplitude of the first extension Lg2. The first extensions Lg1, Lg2, and Lg3 have constant wavelengths and constant flow passage widths.

### Cooling Passages 70

As shown in FIG. 2, in the fuel cell stack 10, the anode separator 51 of one unit cell 20 is in contact with the cathode separator 52 of the unit cell 20 adjacent in the stacking direction. The cooling medium flows between the anode separator 51 and the cathode separator 52 of the two unit cells 20 that contact each other and are adjacent to each other in the stacking direction. A gasket (not shown) that provides a seal between the two unit cells 20 is arranged between the anode separator 51 and the cathode separator 52, which are in contact with each other.

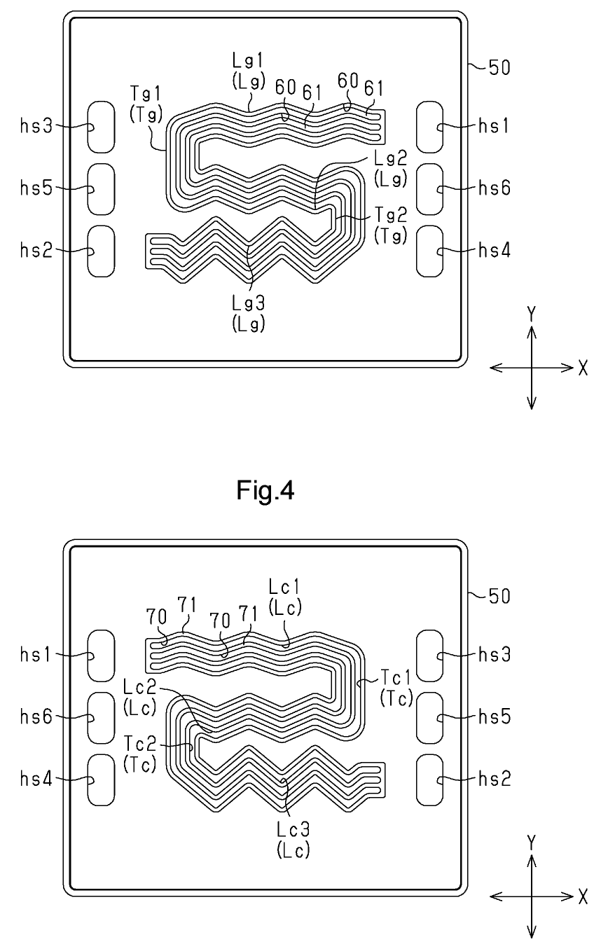

As shown in FIG. 4, the separator 50 includes a second surface opposite the first surface facing the electric power generator 30. The second surface includes cooling passages 70 and ribs 71 extending along the cooling passages 70. The cooling medium flows through the cooling passages 70. The cooling passages 70 and the ribs 71 are arranged in an alternating manner on the second surface. The cooling passages 70 are formed by the back surfaces of the ribs 61. In other words, recesses, which correspond to the ribs 61, in the second surface of the separator 50 define the cooling passages 70. The ribs 71 are formed by the back surfaces of the gas passages 60. In other words, projections, which correspond to the gas passages 60, on the second surface of the separator 50 define the ribs 71.

The separator 50, for example, includes three cooling passages 70 extending side by side. The cooling passages 70 meander back and forth and have serpentine shapes. The cooling passages 70 extend in the Y-axis direction while meandering in the X-axis direction.

Each cooling passage 70 includes three third extensions Lc and two fourth extensions Tc. The three third extensions Lc are arranged side by side in the Y-axis direction. Each fourth extension Tc includes a first end and a second end. Each fourth extension Tc connects the first end of one of the third extensions Lc to the second end of a third extension Lc that is adjacent in the Y-axis direction. Each cooling passage 70 is substantially S-shaped. Each third extension Lc undulates and extends in a meandering manner in the X-axis direction. Each fourth extension Tc extends linearly in the Y-axis direction. The third extension Lc is an example of an “undulating portion”. The fourth extension Tc is an example of a “connection portion”.

In the following description, the three third extensions Lc are referred to as a third extension Lc1, a third extension Lc2, and a third extension Lc3, in order from the upstream side. Further, the two fourth extensions Tc are referred to as a fourth extension Tc1 and a fourth extension Tc2, in order from the upstream side.

An upstream end of the third extension Lc1 is aligned with the through hole hs1 in the X-axis direction. The fourth extension Tc1 connects a downstream end of the third extension Lc1 and an upstream end of the third extension Lc2. The fourth extension Tc2 connects a downstream end of the third extension Lc2and an upstream end of the third extension Lc3. A downstream end of the third extension Lc3 is aligned with the through hole hs2 in the X-axis direction.

The three third extensions Lc, which undulate and extend in a meandering manner, have different amplitudes. More specifically, the amplitude of the third extension Lc that is located on the downstream side in the flow direction of the three third extensions Lc has the greatest amplitude. That is, the amplitude of the third extension Lc2 is greater than the amplitude of the third extension Lc1. The amplitude of the third extension Lc3 is greater than the amplitude of the third extension Lc2. Accordingly, in the fuel cell stack 10, the pressure loss of the cooling medium passing through the three third extensions Lc increases toward the third extension Lc located at the downstream side in the flow direction. The third extensions Lc1, Lc2, and Lc3 have constant wavelengths and constant flow passage widths.

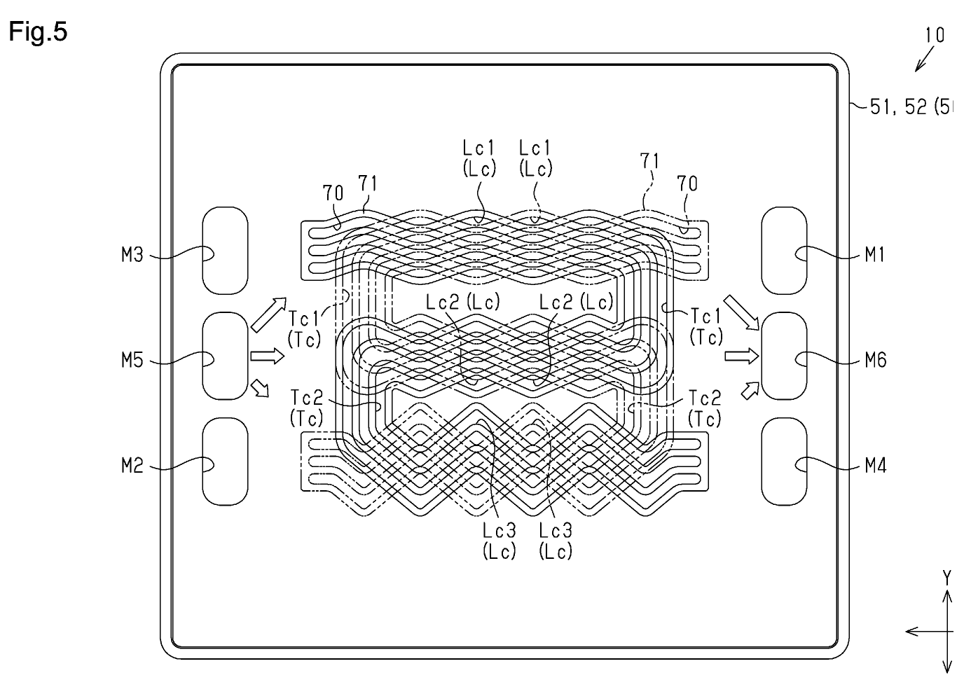

As shown in FIG. 5, the phases of the third extensions Lc1, Lc2, and Lc3 in the anode separator 51 differ from the phases of the third extensions Lc1, Lc2, and Lc3 in the cathode separator 52, which is in contact with the anode separator 51. Thus, the ribs 71 of the anode separator 51 partially contact the ribs 71 of the cathode separators 52.

The cooling medium supply manifold M5 and the cooling medium discharge manifold M6 are located on the opposite sides of the cooling passages 70 in the X-axis direction. More specifically, the cooling medium supply manifold M5 and the cooling medium discharge manifold M6 are located on the opposite sides of the third extension Lc2 in the X-axis direction. The cooling medium supplied from the cooling medium supply manifold M5 flows through the cooling passages 70 of the anode separator 51 and the cooling passages 70 of the cathode separator 52 and is then discharged from the cooling medium discharge manifold M6.

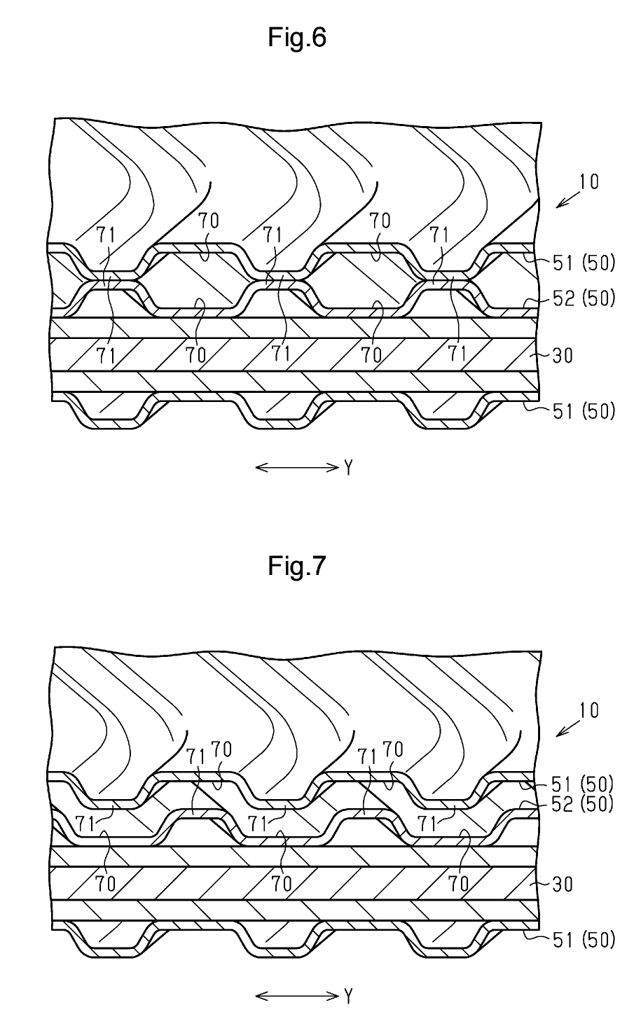

As shown in FIG. 6, portions where the ribs 71 of the anode separator 51 are in contact with the ribs 71 of the cathode separator 52 form closed spaces defined by the cooling passages 70 of the anode separator 51 and the cooling passages 70 of the cathode separator 52. Thus, the cooling medium flows through the closed spaces.

As shown in FIG. 7, the cooling medium flows through the space between the anode separator 51 and the cathode separator 52 at portions where the ribs 71 of the anode separators 51 are separated from the ribs 71 of the cathode separators 52. More specifically, the cooling medium flows over the ribs 71 of the anode separator 51 and the ribs 71 of the cathode separator 52, and through the cooling passages 70 of the anode separator 51 and the cathode separator 52. Thus, the cooling medium flows in the planar direction of the unit cell 20.

### Operation of Present Embodiment

The fuel gas supplied from the fuel gas supply manifold M1 flows through the gas passages 60 of the anode separator 51 of each unit cell 20 and is discharged from the fuel gas discharge manifold M2. The fuel gas flowing through the gas passages 60 is supplied to the electric power generator 30 and diffused by the anode-side gas diffusion layer 32. The oxidant gas supplied from the oxidant gas supply manifold M3 flows through the gas passages 60 of the cathode separator 52 of each unit cell 20 and is discharged from the oxidant gas discharge manifold M4. The oxidant gas flowing through the gas passages 60 is supplied to the electric power generator 30 and diffused by the cathode-side gas diffusion layer 33. Accordingly, electric power is generated in the electric power generator 30 by the electrochemical reaction between the fuel gas and the oxidant gas.

In the fuel cell stack 10, the reactant gas flows through the gas passages 60 of the anode separator 51 and the gas passages 60 of the cathode separator 52 while meandering in opposite directions. Accordingly, the amount of power generated by the unit cell 20 is greater at the upstream side in the flow direction. Thus, the amount of heat generated by the unit cell 20 is greater at the upstream side in the flow direction.

The cooling medium supply manifold M5 and the cooling medium discharge manifold M6 are located at opposite sides of the cooling passages 70 in the X-axis direction. Thus, the cooling medium supplied by the cooling medium supply manifold M5 flows through the third extensions Lc1, Lc2, and Lc3 in the X-axis direction and is then discharged from the cooling medium discharge manifold M6.

In the fuel cell stack 10, the pressure loss of the cooling medium flowing through the three third extensions Lc increases toward the third extension Lc located at the downstream side in the flow direction. Thus, as indicated by the arrows in FIG. 5, the cooling medium supplied from the cooling medium supply manifold M5 readily flows toward the third extensions Lc of which the pressure loss is relatively small in the three third extensions Lc. In other words, the cooling medium flows readily in order of the third extensions Lc1, Lc2, and Lc3. Accordingly, the coolant flows readily toward the portion between the anode separator 51 and the cathode separator 52 at the upstream side in the flow direction, that is, the portion of the unit cell 20 where a relatively large amount of heat is generated.

### Advantages of Present Embodiment

(1) The cooling passage 70 includes the three third extensions Lc and the two fourth extensions Tc. The three third extensions Lc undulate in the X-axis direction and are arranged side by side in the Y-axis direction. Each of the fourth extensions Tc connects the ends of two adjacent third extensions Lc. The cooling medium supply manifold M5 and the cooling medium discharge manifold M6 are located at opposite sides of the cooling passages 70 in the X-axis direction. In the fuel cell stack 10, the pressure loss of the cooling medium flowing through the three third extensions Lc increases toward the third extension Lc located at the downstream side in the flow direction.

This structure, which operates as described above, allows for sufficient cooling of the fuel cell stack 10.

(2) The amplitudes of the three third extensions Lc increase toward the downstream side in the flow direction.

In the above-described structure, the pressure loss of the cooling medium passing through the third extension Lc is adjusted readily for each third extension Lc by changing the amplitude of each third extension Lc.

(3) The cooling passages 70 are formed by the back surfaces of the ribs 61.

When the electric power generator 30 includes the anode-side gas diffusion layer 32 and the cathode-side gas diffusion layer 33, the reactant gas flowing through the gas passages 60 permeates into the anode-side gas diffusion layer 32 and the cathode-side gas diffusion layer 33. This generates electric power in the electric power generator 30. The speed of the reactant gas flowing through the gas passages 60 decreases toward the downstream side of the gas passages 60. Thus, the amount of the reactant gas permeating into the anode-side gas diffusion layer 32 and the cathode-side gas diffusion layer 33 decreases toward the downstream side of the gas passages 60 of the electric power generator 30. This decreases the amount of generated electric power. As a result, the power generation efficiency of the unit cell 20 may be reduced.

In this regard, according to the above-described structure, the cooling passages 70 are formed by the back surfaces of the ribs 61 extending along the gas passages 60. The pressure loss of the cooling medium in the cooling passages 70 is greater at the downstream side in the flow direction than at the upstream side. Thus, the pressure loss of the reactant gas at the downstream side of the gas passages 60 is greater than the pressure loss of the reactant gas at the upstream side. This limits a decrease in the speed of the reactant gas flowing through the gas passages 60 as the reactant gas flows toward the downstream side. In other words, this limits a decrease in the amount of the reactant gas as the reactant gas flows toward the downstream side. This avoids a decrease in the power generation efficiency of the unit cell 20.

### Modifications

The present embodiment may be modified as follows. The present embodiment and the following modifications can be combined as long as the combined modifications remain technically consistent with each other.

The cooling passages 70 do not need to be formed by the back surfaces of the ribs 61 as long as the cooling passages 70 substantially meanders along the gas passages 60. In this case, for example, the first extension Lg of the gas passage 60 may undulate and extend in a meandering manner or may extend in a linearly in the X-axis direction. Such a separator 50, for example, may be formed through machining or laser processing.

The three third extensions Lc do not need to have differing amplitudes as long as the pressure loss of the cooling medium that flows through any one of the third extensions Lc is greater than the pressure loss of the cooling medium that flows through the other third extensions Lc located at the upstream side of any one of the third extensions Lc in the flow direction. For example, the amplitudes of the third extension Lc1 and the third extension Lc2 may be the same, and may be less than the amplitude of the third extension Lc3.

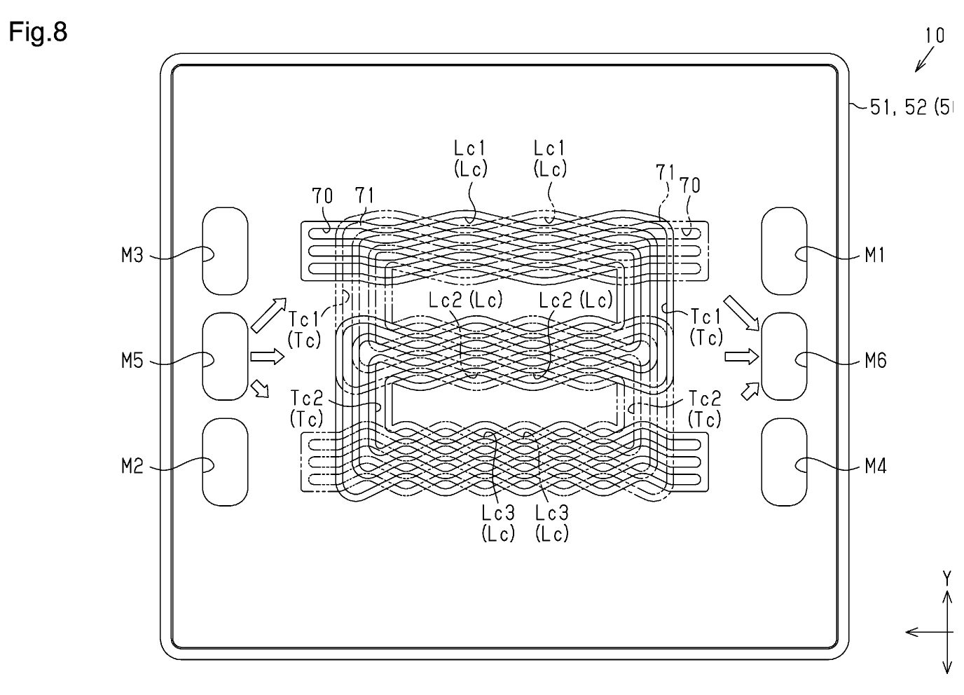

As shown in FIG. 8, the three third extensions Lc may have differing wavelengths so that the pressure loss of the cooling medium flowing through the three third extensions Lc increases toward the third extension Lc located at the downstream side in the flow direction. In a first modification, the wavelengths of the three third extensions Lc decrease toward the third extension Lc located at the downstream side in the flow direction. The amplitudes and the flow passage widths of the third extensions Lc1, Lc2, and Lc3 are constant.

In the first modification, the three third extensions Lc do not need to have differing wavelengths as long as the pressure loss of the cooling medium flowing through any one of the third extensions Lc is greater than the pressure loss of the cooling medium flowing through the other third extension Lc that is on the upstream side of that third extension Lc in the flow direction. For example, the wavelengths of the third extension Lc1 and the third extension Lc2 may be the same and may be greater than the wavelength of the third extension Lc3.

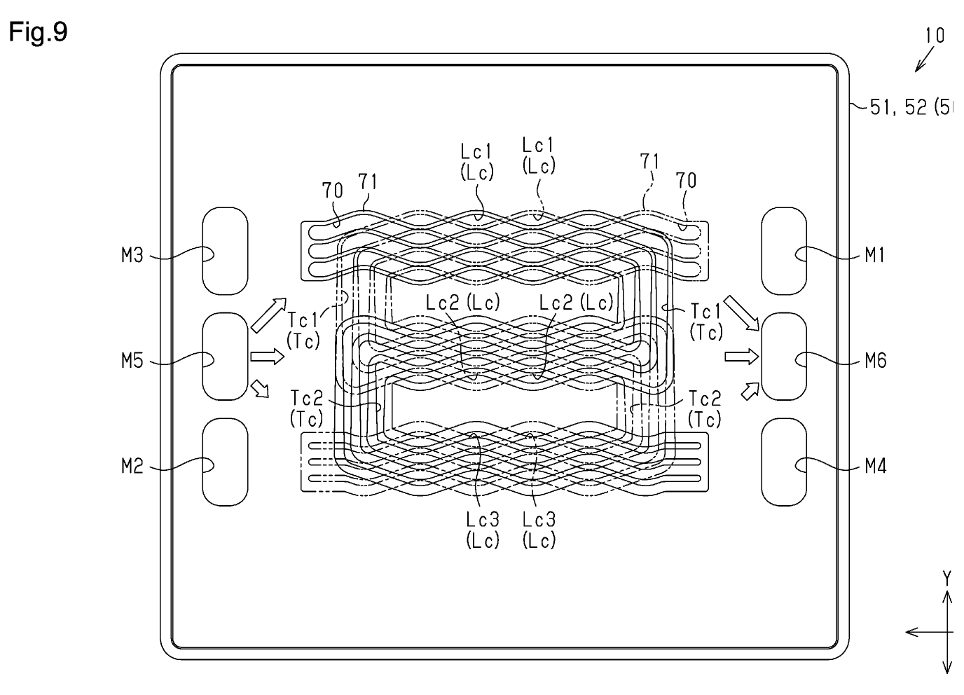

As shown in FIG. 9, the three third extensions Lc may have differing flow passage widths so that the pressure loss of the cooling medium flowing through the three third extensions Lc increases toward the third extension Lc located on the downstream side in the flow direction. In a second modification, the flow passage widths of the three third extensions Lc decrease toward the third extension Lc located on the downstream side in the flow direction. The amplitudes and the wavelengths of the third extensions Lc1, Lc2, and Lc3 are constant. The flow passage width of the fourth extension Tc1 gradually decreases from the third extension Lc1 toward the third extension Lc2. The flow passage width of the fourth extension Tc2 gradually decreases from the third extension Lc2 toward the third extension Lc3.

In the second modification, the three third extensions Lc do not need to have differing flow passage widths as long as the pressure loss of the cooling medium flowing through any one of the third extensions Lc is greater than the pressure loss of the cooling medium flowing through the other third extension Lc that is at the upstream side of the third extension Lc in the flow direction. For example, the flow passage widths of the third extension Lc1 and the third extension Lc2 may be the same and may be greater than the flow passage width of the third extension Lc3.

The above-described embodiment, the first modification, and the second modification may be combined. That is, at least one of the amplitude, the wavelength, and the flow passage width may be different for each third extension Lc so that the pressure loss of the cooling medium passing through the three third extensions Lc increases toward the third extension Lc located on the downstream side in the flow direction.

The fourth extensions Tc1 and Tc2 may undulate and extend in a meandering manner in the Y-axis direction.

The manifolds M1 to M4 may be arranged on two ends of the unit cell 20 in the Y-axis direction. In this case, the upstream end of the extension Lc1 is aligned with the through hole hs1 in the Y-axis direction, and the downstream end of the third extension Lc3 may be aligned with the through hole hs2 in the Y-axis direction.

Each gas passage 60 may include two or four or more first extensions Lg.

Each cooling passage 70 may include two or four or more third extensions Lc.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A fuel cell stack, comprising:
unit cells stacked one above another, wherein
each of the unit cells includes
an electric power generator including a membrane electrode assembly, and
two separators sandwiching the electric power generator,
each of the two separators includes a first surface facing the electric power generator, and a second surface opposite the first surface,
one of the two separators of one of the unit cells is in contact with one of the two separators of an adjacent one of the unit cells in a stacking direction of the unit cells to allow cooling medium to flow therebetween,
a direction orthogonal to the stacking direction is referred to as a first direction, and a direction orthogonal to both the stacking direction and the first direction is referred to as a second direction,
the first surface of each of the two separators includes a gas passage meandering back and forth in the first direction while extending in the second direction, in which reactant gas flows through the gas passage,
the gas passage of each of the two separators in each of the unit cells is formed so that the reactant gas in the gas passage of one of the two separators flows in a direction opposite to a direction in which the reactant gas in the gas passage of the other one of the two separators flows,
the second surface of each of the two separators includes a cooling passage meandering back and forth in the first direction while extending in the second direction, in which the cooling medium flows through the cooling passage,
the cooling passage includes
undulating portions extending in an undulating manner in the first direction and arranged in the second direction, in which each of the undulating portions includes a first end and a second end in the first direction, and
a connecting portion that connects the first end of one of the undulating portions to the second end of an adjacent one of the undulating portions in the second direction,
each of the unit cells includes a cooling medium supply manifold configured to supply the cooling medium to the cooling passage, and a cooling medium discharge manifold configured to discharge the cooling medium from the cooling passage,
the cooling medium supply manifold and the cooling medium discharge manifold are located at opposite sides of the cooling passage in the first direction,
the undulating portions include at least a first undulating portion and a second undulating portion located upstream of the first undulating portion with respect to a flow direction of the reactant gas, and
the cooling medium flowing through the first undulating portion has a greater pressure loss than the cooling medium flowing through the second undulating portion.

2. The fuel cell stack according to claim 1, wherein the first undulating portion has a greater amplitude than the second undulating portion.

3. The fuel cell stack according to claim 1, wherein the first undulating portion has a shorter wavelength than the second undulating portion.

4. The fuel cell stack according to claim 1, wherein the first undulating portion has a smaller flow passage width than the second undulating portion.

5. The fuel cell stack according to claim 1, wherein
the first surface of each of the separators includes ribs extending along the gas passage that are arranged in an alternating manner with the gas passage, and
the cooling passage is formed by back surfaces of the ribs.
